(19) United States
(12) Patent Application Publication
(10) Pub. No.: US 2024/0113587 A1
(43) Pub. Date: Apr. 4, 2024

(54) MOTOR, BLOWER, AND METHOD OF MANUFACTURING MOTOR

(71) Applicant: Nidec Corporation, Kyoto (JP)

(72) Inventors: Yukinobu SHIRAISHI, Kyoto (JP); Takashi UCHINO, Kyoto (JP); Ryota SHIBAHARA, Kyoto (JP); Mikiya IIDA, Kyoto (JP)

(21) Appl. No.: 18/372,268

(22) Filed: Sep. 25, 2023

(30) Foreign Application Priority Data
Sep. 30, 2022 (JP) 2022-157939

(51) Int. Cl. H02K 5/10; F04D 25/06; F04D 29/28; H02K 1/12; H02K 1/22; H02K 7/14; H02K 15/00

(52) U.S. Cl. CPC H02K 5/10; F04D 25/06; F04D 29/281; H02K 1/12; H02K 1/22; H02K 7/14; H02K 15/00

(57) ABSTRACT

A motor includes a rotor rotatable about a central axis extending vertically, a stator radially opposed to the rotor, a circuit board located axially below the stator, a housing in which the rotor, the stator, and the circuit board are accommodated, and a resin portion located on an upper surface of a bottom plate of the housing and covering at least a portion of the stator and the circuit board. The bottom plate of the housing includes a processed portion that is in contact with at least a portion of the resin portion. A surface of the processed portion is rougher than a surface of the bottom plate excluding the processed portion.

### CROSS-REFERENCE TO RELATED APPLICATIONS

The present application claims priority under 35 U.S.C. § 119 to Japanese Patent Application No. 2022-157939, filed on Sep. 30, 2022, the entire contents of which are hereby incorporated herein by reference.

### 1. FIELD OF THE INVENTION

The present disclosure relates to a motor, a blower including a motor, and a method of manufacturing a motor.

### 2. BACKGROUND

In a conventional mold motor, a stator is molded with resin, and a winding coil and a lead wire for motor power supply are sealed with resin and shielded from outside air. Accordingly, it is possible to improve waterproofing, drip-proofing, and rust-proofing performances.

However, in the conventional mold motor, the resin molding is performed according to the radial size of the stator along the axial direction, and thus, the resin becomes thin at the lead wire portion. For this reason, the resin may be peeled off at the lead wire portion, and the sealability may be deteriorated.

### SUMMARY

An example embodiment of a motor of the present disclosure includes a rotor rotatable about a central axis extending vertically, a stator radially opposed to the rotor, a circuit board located axially below the stator, a housing in which the rotor, the stator, and the circuit board are accommodated, and a resin portion located on an upper surface of a bottom plate of the housing and covering at least a portion of the stator and the circuit board. The bottom plate of the housing includes a processed portion that is in contact with at least a portion of the resin portion. A surface of the processed portion is rougher than a surface of the bottom plate excluding the processed portion.

An example embodiment of a blower of the present disclosure includes the above-described motor, and an impeller attached to the rotor to generate an airflow by rotation.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view of a battery portion according to an example embodiment of the present disclosure as viewed from below.

FIG. 2 is a perspective view of a blower according to an example embodiment of the present disclosure as viewed from above.

FIG. 3 is an exploded perspective view of the blower.

FIG. 4 is a plan view of a lower housing according to an example embodiment of the present disclosure.

FIG. 5 is a longitudinal sectional view of the blower.

FIG. 6 is a longitudinal sectional view of a blower according to a first modification of an example embodiment of the present disclosure.

### DETAILED DESCRIPTION

Hereinafter, example embodiments of the present disclosure will be described in detail with reference to the drawings. In the present example embodiment, a central axis Cx is common to a blower A and a motor 100. Further, in the present specification, a direction parallel to the central axis Cx is referred to by the term “axial direction”, a direction perpendicular to the central axis Cx is referred to by the term “radial direction”, and a direction along an arc about the central axis Cx is referred to by the term “circumferential direction”.

In the present specification, the shape and the positional relationship of each portion of the blower A are described with the axial direction as the up-down direction and an intake portion 304 side of a housing 300 as an upper side. The up-down direction is a term used simply for the description and does not limit the positional relationship and the direction of the blower A and the motor 100 while in use. Further, upstream and downstream in the flow direction of the air generated when an impeller 200 rotates are simply referred to as “upstream” and “downstream”. Furthermore, in the present specification, “parallel” includes not only a case of being exactly parallel, but also a case of being arranged side by side without intersecting within a practical range.

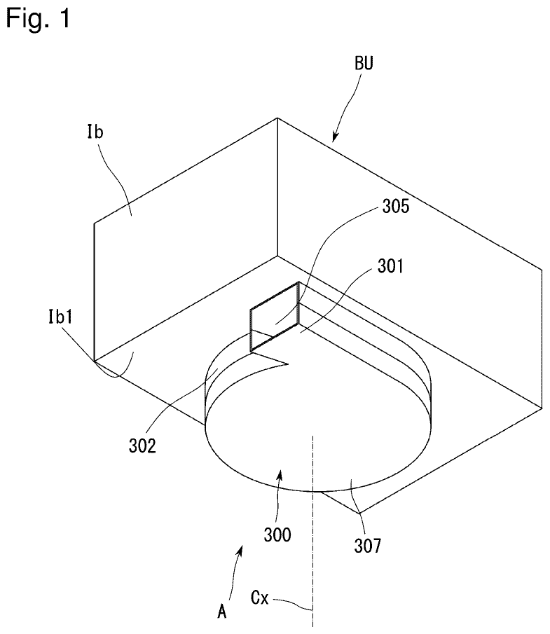

The exemplary blower A of the present disclosure is used, for example, to cool a battery portion BU. Here, the battery portion BU is described with reference to the drawings. FIG. 1 is a perspective view of the battery portion BU as viewed from below.

As illustrated in FIG. 1, the battery portion BU has a rectangular parallelepiped housing box Ib, and internal devices such as a battery cell and a charge control unit (not illustrated) are arranged inside the housing box Ib. The housing box Ib is formed of a material having high thermal conductivity such as an aluminum alloy. The housing box Ib has a flow path (not illustrated) through which the airflow flows, and has an inlet (not illustrated) through which the airflow flows into the flow path and an outlet (not illustrated) through which the airflow flows out. The flow path is isolated from a portion where the internal devices are housed, and the airflow flowing through the flow path is suppressed from direct contact with an article housed in the housing box Ib. As a result, the housing box Ib has waterproofness and dustproofness with respect to the internal devices.

In the housing box Ib, the outlet is formed on a lower surface Ib1, and in the blower A, an intake portion 304, described later, is disposed continuously with the outflow port. The blower A sucks the air from the intake portion 304 and discharges the air from a discharge portion 305 described later. Then, when the air is sucked from the intake portion 304, an airflow is generated in the flow path of the housing box Ib.

In the battery portion BU, when the airflow flows through the flow path, the heat generated from the device disposed in the battery portion is discharged by the airflow. As a result, the battery portion BU is cooled. Note that the method of cooling the battery portion BU is not limited to the method of causing the airflow to flow through the internal flow path. For example, a heat sink to which the heat inside the housing box Ib is transferred may be provided in contact with the housing box Ib, and the heat sink may be cooled by the airflow of the blower A to cool the battery portion BU.

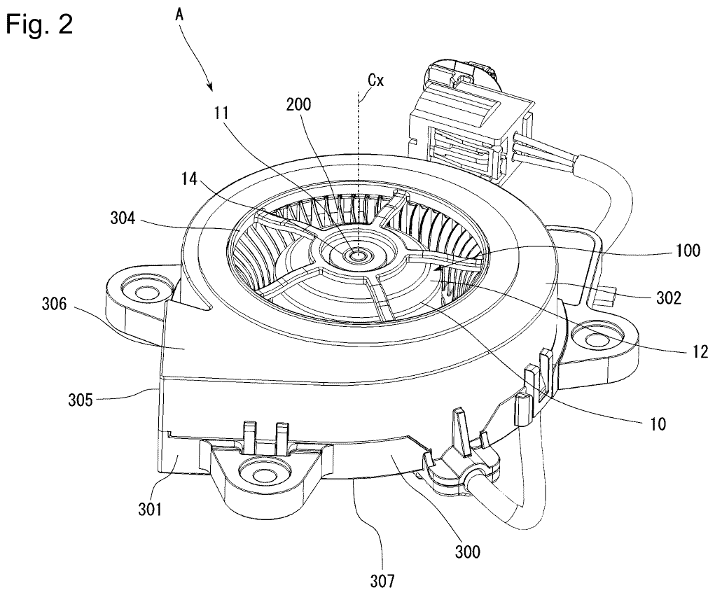

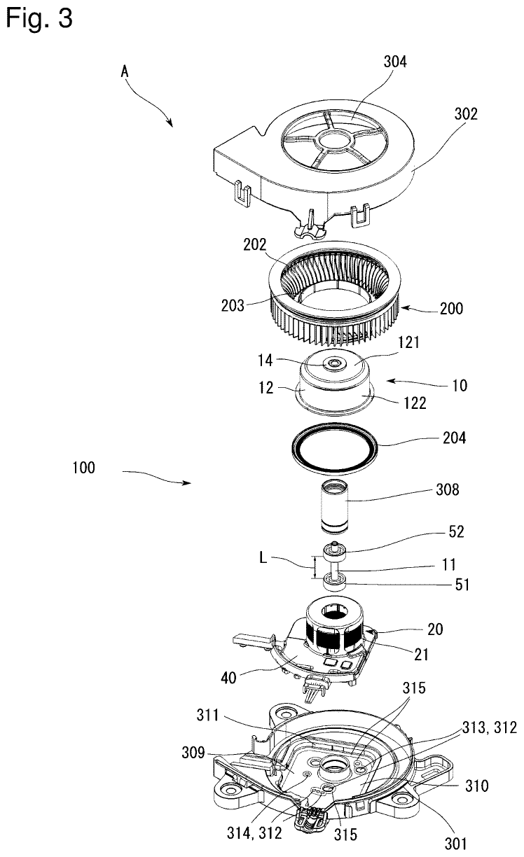

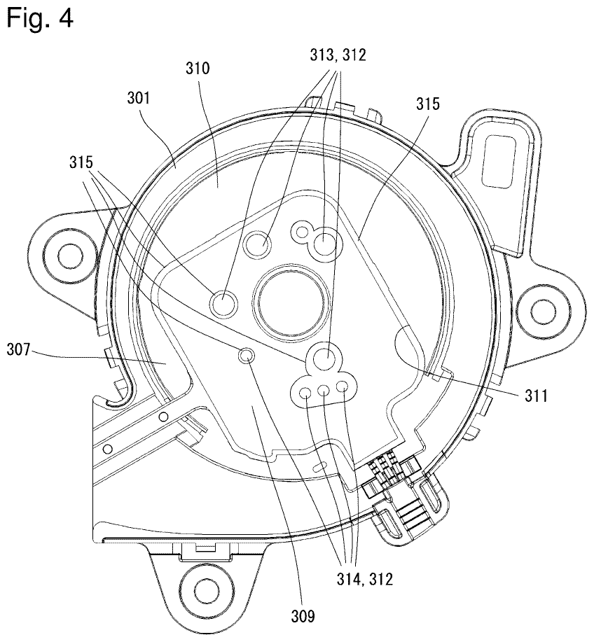

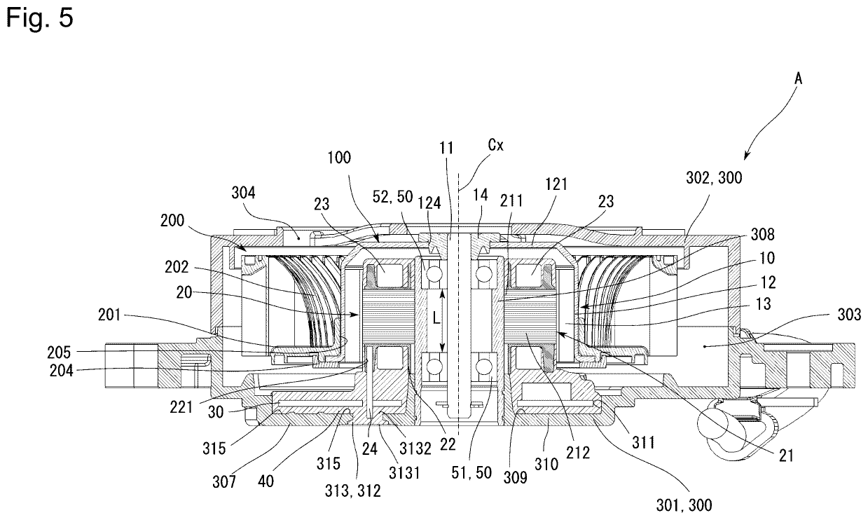

FIG. 2 is a perspective view of the blower A as viewed from above. FIG. 3 is an exploded perspective view of the blower A. FIG. 4 is a plan view of a lower housing 301. FIG. 5 is a longitudinal sectional view of the blower A. As illustrated in FIGS. 2 and 3, the blower A includes the motor 100 and the impeller 200. The motor 100 includes the housing 300 to be described later, and the impeller 200 is accommodated in the housing 300. The impeller 200 is rotated by the motor 100 inside the housing 300. When the impeller 200 rotates, an airflow directed radially outward is generated inside the housing 300. Due to the generation of the airflow by the rotation of the impeller 200, the air flows in from the intake portion 304.

The airflow generated inside the housing 300 moves along the outer edge inside the housing 300, and is discharged from the discharge portion 305 formed at the outer edge portion of the housing 300 and opened in the tangential direction. That is, the blower A includes the motor 100 and the impeller 200 disposed inside the housing 300 and rotated by the motor 100. The rotation of the impeller 200 takes the air into the housing 300 and discharges the compressed air. The housing 300 is an exterior member of the motor 100 and also serves as an exterior member of the blower A. The details of the housing 300 will be described later.

As illustrated in FIGS. 3, 5, and elsewhere, the motor 100 includes a rotor 10, a stator 20, a circuit board 30, a resin portion 40, and the housing 300. The motor 100 is a so-called outer rotor type brushless DC motor, and the rotor 10 that faces the radial outer surface of the stator 20 in the radial direction rotates around the central axis Cx.

The rotor 10 is arranged to be rotatable about the central axis Cx extending vertically. More specifically, the rotor 10 includes a shaft 11, a rotor case 12, a rotor magnet 13, and a shaft fixing part 14. The shaft 11 has a columnar shape centered on the central axis Cx. The shaft 11 rotates about the central axis Cx.

The rotor case 12 is in the shape of a covered cylinder formed of a magnetic material, and includes a lid 121, a cylindrical portion 122, and a flange portion 123. The lid 121 is an annular shape which has, at the center, a through hole 124 penetrating in the axial direction. The cylindrical portion 122 has a cylindrical shape and extends in the axial direction from the radially outer edge of the lid 121. The rotor magnet 13 is fixed to the inner peripheral surface of the cylindrical portion 122.

The shaft fixing part 14 is fixed to the through hole 124 of the lid 121, and the shaft 11 is fixed to the shaft fixing part 14. That is, the rotor 10 and the shaft 11 are fixed by the shaft fixing part 14. The flange portion 123 extends outward in the radial direction from an end portion of the cylindrical portion 122 opposite to the lid 121 in the axial direction. The flange portion 123 has an annular shape.

The rotor magnet 13 has a cylindrical shape. In at least the inner peripheral surface of the rotor magnet 13, N poles and S poles are alternately arranged in the circumferential direction. In the present example embodiment, the rotor magnet 13 has a cylindrical shape, but is not limited thereto. For example, a plurality of flat plate magnets may be arranged and fixed on a cylindrical rotor core in the circumferential direction.

The shaft 11 is rotatably supported by a holder 308, to be described later, of the housing 300 via a bearing part 50. The bearing part 50 includes a first bearing 51 and a second bearing 52. The first bearing 51 and the second bearing 52 have the same configuration. Therefore, the first bearing 51 will be described as a representative.

An inner ring 511 and an outer ring 512 have a tubular shape. In the first bearing 51, the inner ring 511 and the outer ring 512 face each other in the radial direction, and a plurality of balls 513 are disposed between the inner ring 511 and the outer ring 512. For example, the first bearing 51 is a ball bearing.

In the first bearing 51, the inner ring 511 is fixed to the outer peripheral surface of the shaft 11. The outer ring 512 is fixed to the inner peripheral surface of the holder 308. Attachment of the inner ring 511 and the outer ring 512 may be, for example, press fitting, but is not limited to press fitting, and may be deposition, adhesion, welding, or the like. In addition to these, a fixing method in which the movement of the inner ring 511 and the outer ring 512 in the circumferential direction is restricted can be widely adopted.

As described above, the second bearing 52 has the same configuration as that of the first bearing 51. That is, the second bearing 52 includes an inner ring 521 corresponding to the inner ring 511 of the first bearing 51, an outer ring 522 corresponding to the outer ring 512, and a ball 523 corresponding to the ball 513. The second bearing 52 is also attached to the holder 308 of the housing 300 and rotatably supports the shaft 11.

As illustrated in FIGS. 4 and 5, the first bearing 51 holds the lower portion of the shaft 11. The second bearing 52 is disposed above the first bearing 51 of the shaft 11. More specifically, the second bearing 52 holds a portion above the portion held by the first bearing 51 of the shaft 11 by a length L. Since the shaft 11 is held by the first bearing 51 and the second bearing 52, the center thereof overlaps the central axis Cx, and the shaft 11 is rotatable about the central axis Cx.

Since the first bearing 51 and the second bearing 52 are vertically separated from each other to rotatably support the shaft 11, it is possible to suppress the shaft 11 from being inclined with respect to the central axis Cx.

The stator 20 is arranged on the radially inner side of the rotor 10 and faces the rotor 10 in the radial direction. That is, the stator 20 faces the rotor 10 in the radial direction. The stator 20 includes a stator core 21, an insulator 22, a coil 23, and a conductive pin 24. The stator core 21 is a laminated body in which electromagnetic steel sheets are laminated in the axial direction. Note that the stator core 21 is not limited to the laminated body in which the electromagnetic steel sheets are laminated, and may be a single member, such as a fired body of powder or a casting, for example.

The stator core 21 includes an annular core back 211 and a plurality of teeth 212. An inner surface of the annular core back 211 is fixed to the holder 308 of the housing 300. Accordingly, the center of the stator core 21 overlaps the central axis Cx of the motor 100. Note that a fixing member may be interposed between the core back 211 and the holder 308.

The plurality of teeth 212 extend outward in the radial direction from the outer peripheral surface of the core back 211. The plurality of teeth 212 are arranged at regular intervals in the circumferential direction. The insulator 22 is formed of an insulating material such as resin, and covers at least the teeth 212.

The insulator 22 electrically insulates the stator core 21 from the coil 23. The insulator 22 is not limited to resin, and a material capable of insulating the stator core 21 from the coil 23 can be widely adopted. In the case where the conductive wire and the teeth 212 are insulated, the insulator 22 may be omitted.

The coil 23 is formed by winding a conductive wire around the teeth 212 above the insulator 22 which covers the teeth 212. To the coil 23, electric currents of three types having different phases (hereinafter referred to as three phases) are supplied. When a current is supplied to the coil 23, an attractive force or a repulsive force is generated between the coil 23 and the rotor magnet 13. By adjusting the supply timing of the current supplied to the coil 23, the rotor 10 rotates by the attractive force or the repulsive force.

The conductive pin 24 electrically connects the coil 23 and the circuit board 30. As a result, a current is supplied from the circuit board 30 via the conductive pins 24. Each of a U phase current, a V phase current, and a W phase current is supplied to the coil 23. Therefore, the motor 100 has three conductive pins 24. Details of the circuit board 30 will be described later.

The conductive pin 24 is attached to a lower end portion of the insulator 22, and protrudes downward in the axial direction. An end portion of the conducting wire forming the coil 23 is wound around the conductive pin 24. Note that the conductive pin 24 extends straight downward in the axial direction, that is, the conductive pin 24 does not bend. Accordingly, the conducting wire can be easily wound around the conductive pin 24.

Then, the conductive pin 24 and the conducting wire are soldered, whereby the conductive pin 24 and the coil 23 are electrically connected. In the case where the conducting wire is wound around the conductive pin 24 so that the conducting wire and the conductive pin 24 are electrically connected, soldering may be omitted. Further, the conductive pin 24 is electrically connected to a pattern wiring formed on the circuit board 30. That is, the stator 20 includes the conductive pin 24 that electrically connects the coil 23 arranged on the stator 20 and the circuit board 30.

More specifically, the conductive pin 24 is inserted into a conductive pin holder 221 formed on the insulator 22. Accordingly, the conductive pin 24 is fixed to the insulator 22. A lower end portion of the conductive pin 24 is disposed in a first through hole 313 formed in a bottom plate 307, described later, of the housing 300.

The circuit board 30 is disposed below the stator 20 in the axial direction. The pattern wiring is formed on the circuit board 30. Then, electronic components are arranged on the circuit board 30, and a circuit using the electronic components is formed by the pattern wiring. As the circuit board 30, for example, a power supply circuit for supplying electric power to the coil 23 can be exemplified. Further, a circuit other than the power supply circuit may be formed. A through hole is formed in the circuit board 30, and the conductive pin 24 penetrates the through hole. Then, the conductive pin 24 is fixed to the pattern wiring of the circuit board 30 by soldering. Accordingly, the conductive pin 24 is electrically connected to the pattern wiring of the circuit board 30.

In the motor 100, it is preferable that water does not adhere to the coil 23, the circuit board 30, and the electronic components (not illustrated) that are disposed on the surface of the circuit board 30 and constitute a circuit. In addition, a gap, a through hole, and the like are formed in the housing 300 of the motor 100, and water easily enters the inside of the housing 300. Therefore, in the motor 100, the resin portion 40 is disposed to suppress entry of water into the motor 100 and suppress adhesion of water to the coil 23, the circuit board 30, and the electronic components disposed on the circuit board 30.

As illustrated in FIG. 5, the resin portion 40 is disposed on the upper surface of the bottom plate 307 of the housing 300. Then, a part of the stator 20 and the circuit board 30 are covered. The resin portion 40 is in close contact with the bottom plate 307 of the housing 300. As a result, entry of water into the motor 100 is suppressed. Adhesion of water to the coil 23, the circuit board 30, and the electronic components disposed on the surface of the circuit board 30 is suppressed.

Note that even if water, dust, or the like adheres to the radially outer edge of the teeth 212 of the stator core 21, the operation of the motor 100 is less affected. Therefore, in the motor 100 of the present example embodiment, the radially outer edge portion of the teeth 212 is not covered with the resin portion 40.

As illustrated in FIGS. 4 and 5, the housing 300 includes the lower housing 301 and an upper housing 302. In the housing 300, the upper housing 302 is attached axially above the lower housing 301. The rotor 10, the stator 20, and the impeller 200 are disposed in an internal space 303 of the housing 300. More specifically, the rotor 10, the stator 20, and the circuit board 30 are accommodated in the housing.

The housing 300 includes the intake portion 304 and the discharge portion 305. The intake portion 304 is provided on the upper surface of the upper housing 302 and penetrates in the axial direction.

The housing 300 includes a cylindrical portion 306 extending tangentially on a radial outer edge. The discharge portion 305 is an opening formed at an end portion of the cylindrical portion 306. When the impeller 200 rotates inside the housing 300, the airflow sucked from the intake portion 304 flows in the internal space 303 in the circumferential direction and is discharged to the outside from the discharge portion 305.

The lower housing 301 includes the bottom plate 307 and the holder 308. The bottom plate 307 has a plate shape extending in a direction intersecting the central axis Cx. The upper surface of the bottom plate 307 of the housing 300 has a circuit board placement portion 309 vertically opposed to the circuit board 30.

The holder 308 has a tubular shape extending axially upward from a central portion of the bottom plate 307, that is, the circuit board placement portion 309. Here, the holder 308 is fixed to the bottom plate 307, that is, the lower housing 301. The holder 308 is fixed to the bottom plate 307 by press fitting, for example. However, the fixing of the holder 308 to the bottom plate 307 is not limited to press-fitting, and may be fixed by a fixing method such as welding, adhesion, or screwing.

As described above, the stator core 21 is fixed to the outer peripheral surface of the holder 308. The shaft 11 of the rotor 10 is rotatably supported on the inner peripheral surface of the holder 308 via the first bearing 51 and the second bearing 52 of the bearing part 50. The covered cylindrical rotor case 12 is fixed to the shaft 11 via the shaft fixing part 14. The rotor magnet 13 is attached to the inner peripheral surface of the cylindrical portion 122 of the rotor case 12. Therefore, since the shaft 11 is supported by the holder 308 via the bearing part 50, the rotor magnet 13 is arranged to radially face the radially outer edge of the teeth 212 of the stator core 21.

As illustrated in FIGS. 4 and 5, the circuit board placement portion 309 is formed on the bottom surface of a recess 310 recessed downward from the upper surface of the bottom plate 307. The bottom plate 307 has a peripheral wall surface 311 extending upward and surrounding the outer edge of the circuit board placement portion 309.

In the motor 100, in a state where the circuit board 30 is disposed in the circuit board placement portion 309 formed in the recess 310, a resin having fluidity is poured into the recess 310 and cured to form the resin portion 40. At this time, the flow of the resin is stopped by the peripheral wall surface 311. Thus, the resin portion 40 having a constant shape and a constant thickness in the axial direction can be formed.

In the present example embodiment, the configuration in which the recess 310 is formed has been described as an example, but the present disclosure is not limited thereto. For example, an annular rib (not illustrated) protruding in the axial direction from the bottom plate 307 of the lower housing 301 may be formed. In that case, the inner peripheral surface of the rib serves as a peripheral wall surface, and a similar effect can be obtained when the resin is poured.

In addition, the bottom plate 307 has a through hole portion 312 penetrating vertically. The through hole portion 312 has a first through hole 313 and a second through hole 314 having different cross-sectional areas perpendicular to the axial direction. The cross-sectional area of the first through hole 313 is larger than the cross-sectional area of the second through hole 314. That is, the through hole portion 312 has the first through hole 313 and the second through hole 314 having different cross-sectional areas.

As illustrated in FIG. 5, the tip of the conductive pin 24 is disposed in the first through hole 313. That is, the first through hole 313 having a larger cross-sectional area than that of the second through hole 314 overlaps the conductive pin 24 in the axial direction, and the tip of the conductive pin 24 is disposed inside the first through hole 313. As described above, the tip of the conductive pin 24 is disposed inside the first through hole 313, so that the axial length of the motor 100 can be reduced. The first through hole 313 is formed at a position overlapping the conductive pin 24 connected to the coil 23 in the axial direction. The first through hole 313 is formed at a position overlapping the through hole in the axial direction.

A part of the resin portion 40 is disposed in the first through hole 313. As illustrated in FIG. 5, the area of an opening 3131 on the upper surface side of the first through hole 313 is smaller than the area of an opening 3132 on the lower surface side. Since a part of the resin portion 40 is disposed in the first through hole 313, a lower portion of the resin portion 40 disposed in the first through hole 313 is larger than an upper portion thereof. Therefore, the resin portion 40 filled in the lower-side opening 3131 of the first through hole 313 cannot pass through the upper-side opening 3132. As a result, it is possible to suppress the resin portion 40 from coming out upward in the axial direction, the resin portion 40 from being peeled off from the inner peripheral surface of the first through hole 313, and the like. As a result, it is possible to suppress water from entering the inside through the through hole portion 312, and it is possible to suppress adhesion of moisture to the wiring pattern of the circuit board 30 and the electronic component attached to the circuit board 30.

As illustrated in FIG. 5 and the like, in the motor 100, the first through hole 313 has a shape in which cylinders having different inner diameters are combined in the axial direction, but is not limited thereto. For example, the inner diameter may be continuously deformed such as a tapered shape or a bell mouth shape.

As illustrated in FIG. 4, the second through hole 314 has a cross-sectional area smaller than that of the first through hole 313. The resin portion 40 is formed by pouring resin between the circuit board 30 and the lower housing 301 and curing the resin. When the resin is poured, the air between the lower housing 301, the circuit board 30, and the resin portion 40 is pushed by the resin.

The air pushed by the resin is discharged from the first through hole 313 and the second through hole 314. As a result, formation of a cavity in the cured resin portion 40 is suppressed, and the degree of close contact between the resin portion 40 and the lower housing 301 can be increased.

As described above, the first through hole 313 is a through hole in which a part of the conductive pin 24 is disposed. Even when the position of the conductive pin 24 is shifted, a part of the conductive pin 24 is disposed inside the first through hole 313, so that the first through hole 313 is formed as a through hole having a certain cross-sectional area. Further, since the cross-sectional area of the first through hole 313 is larger than the cross-sectional area of the second through hole 314, even when a part of the conductive pin 24 is disposed, the air pushed by the resin from the first through hole 313 is quickly discharged as similar to the case of the second through hole 314. As a result, a cavity is less likely to be formed, and the degree of close contact between the resin portion 40 and the lower housing 301 can be increased.

The second through hole 314 is preferably formed at a place where the air surrounded by the resin is easily discharged when the resin is poured. Similarly to the first through hole 313, the second through hole 314 may have an upper cross-sectional area smaller than a lower cross-sectional area. In this way, similarly to the first through hole 313, the resin portion 40 is prevented from coming off. In addition, since the resin portion 40 is disposed in the first through hole 313 and the second through hole 314, the movement of the resin portion 40 in the direction along the bottom plate 307 of the lower housing 301 is also restricted.

The first through hole 313 and the second through hole 314 are connected to the outside of the motor 100 at the lower end. Therefore, water easily enters from a boundary portion between the resin portion 40 and each of the first through hole 313 and the second through hole 314. Therefore, the lower housing 301 includes a processed portion 315 that surrounds the peripheral portions of the first through hole 313 and the second through hole 314. That is, the processed portion 315 surrounds the peripheral portion of the through hole portion 312. The peripheral portion of the through hole portion 312 is an annular portion that is in contact with the outside of the through hole portion 312 and has a constant width when viewed in the axial direction. The processed portion 315 is covered with the resin portion 40 and comes into contact with the resin portion 40. That is, the bottom plate 307 of the housing 300 has the processed portion 315 covered with at least a part of the resin portion 40.

The surface of the processed portion 315 is rougher than the portion other than the processed portion 315 of the bottom plate 307. The processed portion 315 is formed by, for example, emitting laser light to dissolve a part of the lower housing and roughen the surface. The processed portion 315 is not limited to this configuration. For example, the processed portion 315 may be formed by a process of dissolving the surface using a chemical. Furthermore, the surface may be processed by machining such as sandblasting or cutting.

Since the surface of the processed portion 315 is rougher than the other portions of the bottom plate 307, adhesion to the resin portion 40 is enhanced. Therefore, the waterproof property of the portion where the processed portion 315 and the resin portion 40 are in contact with each other can be enhanced. As a result, it is possible to suppress adhesion of moisture to the wiring pattern of the circuit board 30 and the attached electronic component.

Even if water enters through the gap between the through hole portion 312 and the resin portion 40, it is possible to suppress water from entering inside the peripheral portion of the through hole portion 312. As a result, it is possible to suppress adhesion of moisture to the wiring pattern of the circuit board 30 and the attached electronic component.

For example, the housing 300 may be formed of a fiber-reinforced resin. In such a case, the surface may be scraped by irradiation with a laser beam, application of a chemical, or machining to a predetermined position of the lower housing 301 to expose the fiber or the fiber to which the resin is attached. That is, in a case where the housing 300 is formed of a fiber-reinforced resin, a fiber portion which is a part of a material constituting the housing 300 is exposed in the processed portion 315. With such a configuration, adhesion between the processed portion 315 and the resin portion 40 can be enhanced. In addition, since the fiber portion is exposed, the operator can easily confirm the state of the processed portion 315, and the processed portion 315 can be reliably formed.

When the blower A is operating, air is sucked from the intake portion 304. At that time, water (moisture) may be sucked together with air. This moisture may adhere to the interior of the housing 300, flow into the lower housing 301, and enter the recess 310. Therefore, the processed portion 315 may be formed in at least a part of the circuit board placement portion 309. More specifically, the processed portion 315 may have an annular shape formed at the outer edge portion of the circuit board placement portion 309 (see FIG. 4).

As described above, by forming the annular processed portion 315 on the outer edge portion of the circuit board placement portion 309, adhesion between the circuit board placement portion 309 and the resin portion 40 can be enhanced. As a result, it is possible to suppress the water flowing through the recess 310 from coming into contact with the circuit board 30 and the electronic components attached to the circuit board 30. In addition, by forming the processed portion 315 in a part of the circuit board placement portion 309, it is possible to save time and labor required for processing for forming the processed portion 315.

Next, a process of manufacturing the resin portion 40 will be described. First, the circuit board 30 is disposed on the circuit board placement portion 309 of the lower housing 301. Thereafter, the stator core 21 in which the insulator 22 and the coil 23 are disposed on the teeth 212 is fixed to the outer peripheral surface of the holder 308. At this time, the end portion of the conducting wire of the coil 23 is wound around the conductive pin 24 and electrically connected by soldering. Then, the conductive pin 24 is electrically connected to the pattern wiring of the circuit board 30 by soldering.

In this state, a mold surrounding the stator 20 and the circuit board 30 is attached, and the molten resin is poured into the mold. After the resin is discharged from the first through hole 313 and the second through hole 314, the resin is cured to form the resin portion 40. At that time, the resin portion 40 comes into contact with the processed portion 315 annularly formed at positions surrounding the first through hole 313 and the second through hole 314 and an outer edge portion of the circuit board placement portion 309. As a result, the resin portion 40 and the processed portion 315, that is, the lower housing 301, are brought into close contact with each other. As a result, entry of water into the motor 100 is suppressed.

In the present example embodiment, the processed portion 315 is formed in the outer edge portion of the circuit board placement portion 309, but the present disclosure is not limited thereto. For example, the processed portion 315 may also be formed on the peripheral wall surface 311. With such a configuration, it is possible to suppress adhesion of moisture to the wiring pattern of the circuit board 30 and the electronic components attached to the circuit board 30 from the gap between the circuit board 30 and the resin portion 40. Furthermore, the processed portion 315 may be formed on the inner peripheral surfaces of the first through hole 313 and the second through hole 314.

The impeller 200 is arranged inside the housing 300. The impeller 200 includes a base plate 201, a plurality of blades 202, an attaching portion 203, and a connection portion 204.

The base plate 201 is an annular shape which has, at the radial center, a through hole 205 penetrating in the axial direction. The base plate 201 is perpendicular to the central axis Cx. The plurality of blades 202 are attached to the base plate 201. The plurality of blades 202 are arranged at regular intervals in the circumferential direction. The attaching portion 203 has a cylindrical shape that protrudes in the axial direction from the peripheral portion of the through hole 205 of the base plate 201.

The inner circumferential surface of the attaching portion 203 is brought into contact with the outer peripheral surface of the cylindrical portion 122 of the rotor case 12. At this time, the axial lower surface of the attaching portion 203 comes into contact with the flange portion 123 of the rotor case 12. Accordingly, the impeller 200 is positioned in the axial direction and attached to the rotor 10.

Note that the attaching portion 203 and the cylindrical portion 122 are fixed by, for example, press-fitting. The fixing method is not limited to press-fitting, and a fixing method capable of firmly fixing the attaching portion 203 and the cylindrical portion 122, such as adhesion, deposition, and welding, can be widely adopted.

The connection portion 204 has an annular shape. The connection portion 204 comes into contact with the lower surfaces of the base plate 201 and the flange portion 123 to connect the rotor 10 and the impeller 200. When the rotor 10 and the impeller 200 are firmly fixed, the connection portion 204 may be omitted. In the blower A, the impeller 200 is attached to the rotor 10 and rotates to generate an airflow.

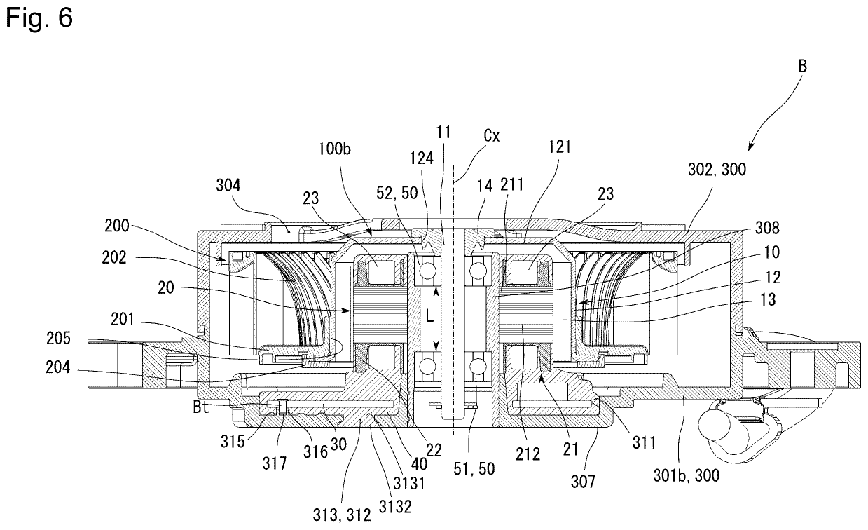

FIG. 6 is a longitudinal sectional view of a blower B according to a first modification. The blower B illustrated in FIG. 6 is different from the blower A illustrated in FIG. 5 in that a housing 300b of a motor 100b includes a pedestal portion 316 that holds the circuit board 30 and does not include the conductive pin 24. Besides this, the blower B has the same configuration as that of the blower A. Therefore, substantially the same parts of the blower B as those of the blower A are denoted by the same reference numerals, and the detailed description of the same parts will be omitted.

As illustrated in FIG. 6, a bottom plate 307 of a lower housing 301b of the housing 300b has the pedestal portion 316 protruding axially upward from the upper surface of the recess 310. In FIG. 6, one pedestal portion 316 is illustrated in the lower housing 301b, but a plurality of pedestal portions is actually arranged. The circuit board 30 is preferably held at three or more stable points, and the number of pedestal portions 316 is preferably three or more. That is, the bottom plate 307 of the housing 300b has the plurality of pedestal portions 316 protruding upward from the upper surface.

The housing 300b has the pedestal portion 316 protruding axially upward from the bottom portion of the circuit board placement portion 309. The pedestal portion 316 includes an internal thread 317. A through hole 31 penetrating in the thickness direction is formed in the circuit board 30. When the circuit board 30 is disposed on the upper portion of pedestal portion 316, the through hole 31 of circuit board 30 axially overlaps the internal thread 317 of pedestal portion 316.

In a state where the circuit board 30 is disposed on the pedestal portion 316, a screw Bt is inserted into the through hole 31 from above the circuit board 30 and screwed into the internal thread 317. As a result, the circuit board 30 is fixed to the lower housing 301b in a state of being separated from the bottom portion of the circuit board placement portion 309.

Then, in the vicinity of the pedestal portion 316 of the bottom plate 307, a processed portion 315 surrounding the pedestal portion 316 is formed. That is, the processed portion 315 surrounds the pedestal portion 316. Note that the processed portion 315 may be formed on the surface of the pedestal portion 316. Although the circuit board 30 and the pedestal portion 316 are fixed by the screw Bt, the present disclosure is not limited thereto. For example, a fixture different from a screw such as a rivet or a pin may be employed. In addition, a fixing method such as welding or adhesion may be adopted. A fixing method for strengthening the circuit board 30 and the pedestal portion 316 can be widely adopted.

That is, the circuit board 30 is disposed on the upper portion of the pedestal portion 316, and is fixed to the bottom plate 307 of the housing 300b by the fixture Bt that penetrates the circuit board 30 from the upper surface and is fixed to the pedestal portion 316.

In this manner, the stator 20 is fixed to the holder 308 in a state where the circuit board 30 is fixed to the lower housing 301b. Since the circuit board 30 is fixed to the pedestal portion 316, the end of the conductive wire forming the coil 23 of the stator 20 fixed to the holder 308 can be directly and electrically connected to the power supply circuit of the circuit board 30. Thus, the conductive pin 24 can be omitted.

Then, as described above, a mold that covers the stator 20 and the circuit board 30 is attached, and resin is poured. Since the circuit board 30 is fixed to the upper portion of the pedestal portion 316, a gap is formed between the circuit board 30 and the bottom portion of the circuit board placement portion 309. Therefore, the resin easily flows between the circuit board 30 and the circuit board placement portion 309, and the circuit board 30 is easily surrounded by the resin. As a result, the resin portion 40 can be formed in a short time with high accuracy.

Then, the resin portion 40 is in close contact with the processed portion 315 formed around the pedestal portion 316. By providing the processed portion 315 around the pedestal portion 316, it is possible to enhance the adhesion of a portion where the processed portion 315 and the resin portion 40 are in contact with each other around the pedestal portion 316, and water hardly reaches the pedestal portion 316. Accordingly, it is possible to suppress water from reaching the circuit board 30 along the pedestal portion 316 and the screw Bt. As a result, it is possible to suppress adhesion of moisture to the wiring pattern of the circuit board 30 and the electronic components mounted on the circuit board 30.

While the example embodiments of the present disclosure have been described above, the example embodiments can be modified in various ways within the scope of the present disclosure.

Example embodiments of the present disclosure are applicable to, for example, a motor and a blower including the motor.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor rotatable about a central axis extending vertically;
a stator radially opposed to the rotor;
a circuit board located below the stator in an axial direction;
a housing in which the rotor, the stator, and the circuit board are accommodated; and
a resin portion located on an upper surface of a bottom plate of the housing and covering at least a portion of the stator and the circuit board; wherein
the bottom plate of the housing includes a processed portion that is covered with at least a portion of the resin portion; and
a surface of the processed portion has a surface roughness that is higher than a surface roughness of a surface of the bottom plate excluding the processed portion.

2. The motor according to claim 1, wherein
the bottom plate of the housing includes a through hole portion penetrating vertically; and
the processed portion surrounds a peripheral portion of the through hole portion.

3. The motor according to claim 2, wherein an area of an upper-side opening of the through hole portion is smaller than an area of a lower-side opening of the through hole portion.

4. The motor according to claim 2, further comprising:
a conductive pin electrically connecting a coil located on the stator and the circuit board; wherein
the through hole portion includes a first through hole and a second through hole with different cross-sectional areas;
the first through hole has a larger cross-sectional area than that of the second through hole and overlaps the conductive pin in the axial direction; and
a tip of the conductive pin is located inside the first through hole.

5. The motor according to claim 2, wherein
the bottom plate of the housing includes pedestal portions protruding upward from the upper surface;
the circuit board is located on an upper portion of each of the pedestal portions, and is fixed to the bottom plate of the housing by a fixture penetrating the circuit board from an upper surface and fixed to the pedestal portion; and
the processed portion surrounds the pedestal portions.

6. The motor according to claim 1, wherein
the upper surface of the bottom plate of the housing includes a circuit board placement portion vertically opposed to the circuit board; and
the processed portion is provided in at least a portion of the circuit board placement portion.

7. The motor according to claim 6, wherein the processed portion has an annular shape defined in an outer edge portion of the circuit board placement portion.

8. The motor according to claim 2, wherein
the upper surface of the bottom plate of the housing includes a circuit board placement portion vertically opposed to the circuit board; and
the processed portion is in an annular shape and is also defined in an outer edge portion of the circuit board placement portion.

9. The motor according to claim 6, wherein the bottom plate includes a peripheral wall surface that extends upward and surrounds an outer edge of the circuit board placement portion.

10. The motor according to claim 9, wherein the circuit board placement portion is provided on a bottom surface of a recess that is recessed downward from the upper surface of the bottom plate.

11. The motor according to claim 9, wherein the processed portion is also on the peripheral wall surface.

12. The motor according to claim 1, wherein
the housing is made of a fiber-reinforced resin; and
a fiber portion that is a portion of a material included in the housing is exposed in the processed portion.

13. A blower comprising:
the motor according to claim 1; and
an impeller inside the housing and rotatable by the motor; wherein
the blower is operable to take air into the housing and discharge compressed air by rotation of the impeller.

14. A blower comprising:
the motor according to claim 12; and
an impeller inside the housing and rotatable by the motor; wherein
the blower is operable to take air into the housing and discharge compressed air by rotation of the impeller.

15. A method of manufacturing a motor in which a rotor, a stator, and a circuit board are accommodated in a housing, the method comprising:
forming a processed portion at a predetermined position on an upper surface of a bottom plate of the housing, the processed portion having a surface roughness higher than a surface roughness of another portion; and
providing a resin in contact with the processed portion and covering at least a portion of the stator and the circuit board with the resin.
